(19) United States
(12) Patent Application Publication
(10) Pub. No.: US 2014/0156470 A1
(43) Pub. Date: Jun. 5, 2014

(54) METHOD AND SYSTEM FOR PROVIDING A TRANSIENT VIRTUAL SHOP

(71) Applicant: Madhusudan RAMAN, Sherborn, MA (US)

(72) Inventor: Madhusudan RAMAN, Sherborn, MA (US)

(73) Assignee: Verizon Patent and Licensing Inc., Basking Ridge, NJ (US)

(21) Appl. No.: 13/693,599

(22) Filed: Dec. 4, 2012

(51) Int. Cl. G06Q 30/06

(52) U.S. Cl. CPC G06Q 30/0641
USPC 705/27.1

(57) ABSTRACT

An approach for providing a transient virtual shop is described. A transaction request is received, from a mobile device, for a virtual merchant service. Contextual information relating to the mobile device is determined. Communication is initiated with a merchant system configured to facilitate a transaction associated with the merchant service. Transaction data is received from the merchant system based on the determined contextual information. Transmission of the transaction data is initiated to the mobile device for presentation, wherein the presentation includes projecting a graphical user interface to represent the transaction data. The graphical user interface supports gesture-based input. User input corresponding to the transaction is received via the graphical user interface.

### BACKGROUND INFORMATION

Digital or electronic commerce (e.g., on-line or web-based transactions) has become a mainstay for merchants (retailers) in the selling of products and services. Traditionally, merchant systems have operated independently from other service providers (e.g., telecommunications) in pursuing their objectives. There exists little or no integration of services and technologies. Merchant systems are designed around available technologies (which may be inadequate). This non-integrated approach can impede the implementation of relevant technologies to advance both the objectives of the merchants and the telecommunication service providers. Consumption of products and services, from the consumer's perspective, is fueled largely by convenience and costs. For example, to reduce store front costs, retailers may utilize kiosks as transaction points for the sale of their goods and services. However, although kiosks have relatively good portability, they can be expensive and time consuming to set-up and maintain, and also require some physical real estate. Thus, operational costs of kiosks can be high. Strictly on-line shops, lack personal and digital social interaction; such interaction can greatly stimulate a sale of the product or service.

Based on the foregoing, there is a need for providing a virtual shop or store that preserves effective user interaction at a personal and social level in a physical context transforming it from a strictly on-line context, while minimizing operational costs.

### BRIEF DESCRIPTION OF THE DRAWINGS

Various exemplary embodiments are illustrated by way of example, and not by way of limitation, in the figures of the accompanying drawings in which like reference numerals refer to similar elements and in which:

FIG. 1 is a diagram of a system for providing virtual shop services in support of one or more merchant services, according to one embodiment;

FIG. 2A is a diagram depicting the lifecycle managed service specific components of a virtual shop services platform, according to one embodiment;

FIG. 2B is a diagram depicting the components of a virtual shop services platform, according to one embodiment;

FIG. 3 is a diagram of a mobile device configured to project a user interface in support of a transient virtual shop, according to one embodiment;

FIG. 4 is a flowchart of process for providing virtual shop services by a service provider, according to one embodiment;

FIG. 5 is a flowchart of process for providing interaction via a mobile device in support of virtual shop services, according to one embodiment;

FIG. 6 is a diagram of a mobile device configured to project a user interface in support of a transient virtual shop from a shop-side perspective, according to one embodiment;

FIG. 7 is a diagram of a use case involving a consumer-side user interface relating to a transient virtual shop, according to one embodiment;

FIG. 8 is a diagram of a computer system that can be used to implement various exemplary embodiments; and

FIG. 9 is a diagram of a chip set that can be used to implement an embodiment of the invention.

### DESCRIPTION OF THE PREFERRED EMBODIMENT

An apparatus, method and software for providing a transient virtual shop are described. In the following description, for the purposes of explanation, numerous specific details are set forth in order to provide a thorough understanding of the present invention. It is apparent, however, to one skilled in the art that the present invention may be practiced without these specific details or with an equivalent arrangement. In other instances, well-known structures and devices are shown in block diagram form in order to avoid unnecessarily obscuring the present invention.

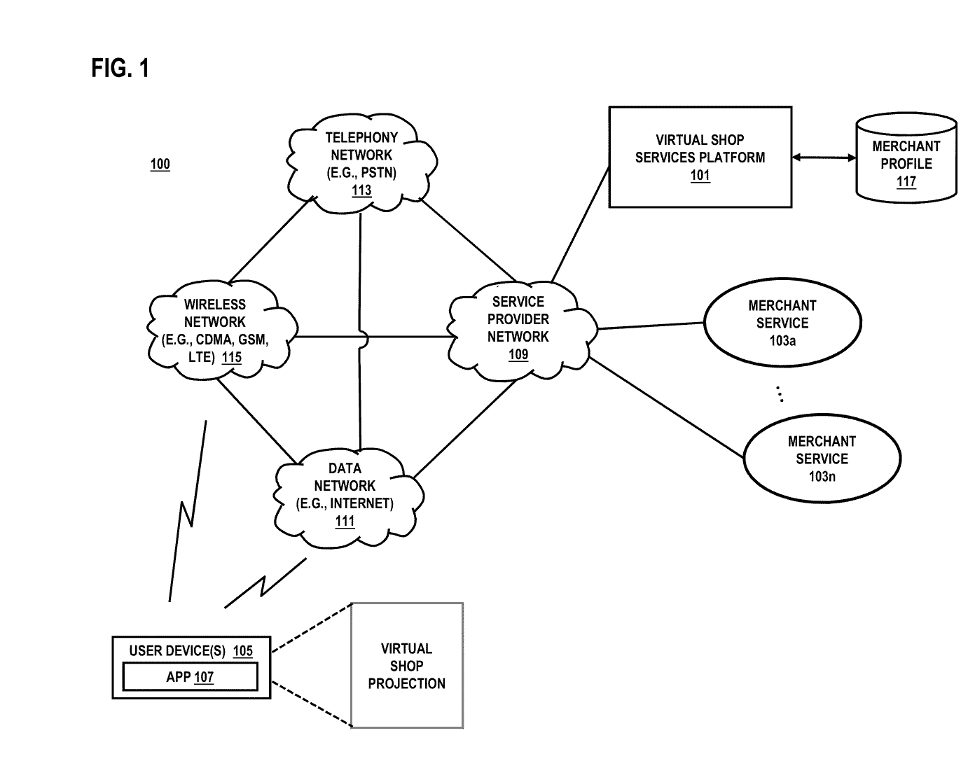

FIG. 1 is a diagram of a system for providing virtual shop services in support of one or more merchant services, according to one embodiment. For the purposes of illustration, system 100 includes a virtual shop services platform 101 that provides a virtual store front to be presented to consumers of the merchant services 103a-103n. The virtual shop services platform 101, in this example, is operated and maintained by a service provider, which can serve multiple merchant services 103a-103n. By way of example, a merchant user (e.g., representative or agent of the merchant) may employ a user device 105 that executes a virtual shop application 107 to enable projection of a virtual store front onto any available surface for presentation to a potential consumer. That is, the virtual store front can be projected on to a passive physical surface that is made interactive through a gesture-based user interface. The shop can be created with content from a digital commerce site of a merchant system (e.g., merchant service 103a). Platform 101 enhances the shop with “hyper localization” services that support a virtual store perimeter, digital payment acceptance, remote inventory and incentive management on the user device 105, which may be a mobile tablet device.

The virtual shop services functions of platform 101 stem from the recognition that the e-commerce world have evolved such that even small organizations as well as individuals can readily participate in the ubiquitous virtual retailing industry, as the cost of entry continues to decline. Additionally, it is recognized that the human, personal “sales” interaction needs to be retained such that a completely on-line presence may be inadequate to promote sales revenue. The virtual store front enabled by platform 101 can permit a cost-effective deployment of a transient (or mobile) store front for a vendor. This virtual store front can complement a purely on-line or web presence, thereby expanding the sales channels.

The virtual shop services platform 101 may be implemented for execution within a service provider network as a cloud service or a hosted service, for instance. According to certain embodiments, one or more networks, such as data network 111, telephony network 113 and/or wireless network 115, can interact with the service provider network 109. Networks 109-115 may be any suitable wireline and/or wireless network, and be managed by one or more service providers. For example, telephony network 113 may include a circuit-switched network, such as the public switched telephone network (PSTN), an integrated services digital network (ISDN), a private branch exchange (PBX), or other like network. Wireless network 115 may employ various technologies including, for example, code division multiple access (CDMA), long term evolution (LTE), enhanced data rates for global evolution (EDGE), general packet radio service (GPRS), mobile ad hoc network (MANET), global system for mobile communications (GSM), Internet protocol multimedia subsystem (IMS), universal mobile telecommunications system (UMTS), etc., as well as any other suitable wireless medium, e.g., microwave access (WiMAX), wireless fidelity (WiFi), satellite, and the like. Meanwhile, data network 111 may be any local area network (LAN), metropolitan area network (MAN), wide area network (WAN), the Internet, or any other suitable packet-switched network, such as a commercially owned, proprietary packet-switched network, such as a proprietary cable or fiber-optic network.

Although depicted as separate entities, networks 109-115 may be completely or partially contained within one another, or may embody one or more of the aforementioned infrastructures. For instance, service provider network 109 may embody circuit-switched and/or packet-switched networks that include facilities to provide for transport of circuit-switched and/or packet-based communications. It is further contemplated that networks 109-115 may include components and facilities to provide for signaling and/or bearer communications between the various components or facilities of system 100. In this manner, networks 109-115 may embody or include portions of a signaling system 7 (SS7) network, Internet protocol multimedia subsystem (IMS), or other suitable infrastructure to support control and signaling functions. The platform 101 may be further interfaced with external networks, including those of third party content providers (e.g., advertisements), by way of various network interface and sharing arrangements and policies to integrate with one or more merchant services.

According to certain embodiments, service provider network 109 may be a cloud based system that delivers the transient virtual shop via the virtual shop services platform 101. The virtual shop services platform 101 is implemented as a managed service platform that is a cloud based system capable of being deployed as individual cloud instances supporting different store chains. Additionally, any one or more of the merchant services 103a-103n can also be cloud based system. As shown, virtual shop services platform 101 can maintain a merchant profile database 117 to store the various preferences and parameters for each of the merchant services 103a-103n.

By way of example, merchant service 103a includes various systems and software to support the sale and payment processing for goods and/or services and for interacting with virtual shop services platform 101. Platform 101 can include a “project-a-shop” server that utilizes a merchant cloud web services interface to reach into the merchant cloud inventory maintained on an inventory server of merchant service 103a Inventory specific manipualtions are performed via inventory management functions associated with the merchant service 103a, for instance, to categorize current stored inventory. Platform 101 can also be configured to manage order to cash lifecycle for the merchant (e.g., merchant 103a) via a provisioning system of merchant services 103a. For example, such merchant services 103 can employ an order management subsystem (e.g., implemented via a server) that creates and updates existing orders. The orders may be are marked as “manageable” by merchant service 103a to indicated that such orders are under the control or accessible by platform 101.

In addition, merchant service 103a can employ a merchant branded project-a-shop web site, which hosts a shop instance interface that serves incoming requests from data network 111 (e.g., the public Internet) from duly authorized user devices 105 (e.g., mobile tablet devices). These devices 105, in certain embodiments, are capable of projecting a virtual shop to a potential consumer using, for example, a pico-projector with Holography Laser projection with IR interface or an ultrasound interface. This projector may be integrated with the user device 105 or may be a standalone peripheral device. In either case, the projector projects a user interface onto a passive surface such as a wall or capacitative embedded glass display. It is noted that selection locations between the surface and the device 105 can be actively translated by a hyper-localization layer acquired (e.g., downloaded) via the virtual shop services platform 101 and downloaded onto the devices 105. Hyper localization services refer to services associated with a square meter tile within, for example, a 100 square meter location. These include the management of services to maintain a perimeter and an interactive volume of space within the perimeter.

The translations map the hyper-locale of the selection on to user triggers for selected actions that are carried out in the merchant service 103a (e.g., using the merchant cloud via the merchant web service).

Virtual shop service functionality supported by platform 101 are, in some embodiments, contextual to a small geographical location perimeter (hyper-locale) that act as live gesture space via a machine to physical space interpretation component. The projected content triggers interaction with the cloud based shop inventory as well as the accrual of incentives for engaging in browsing and purchase behavior. Digital payment can be a supported mechanism via a payment function (e.g., payment card industry (PCI) complaint server) that is supported by a web service interface of platform 101. Such payment may be in form of traditional card payment acceptance enabled by the mobile tablet device 105.

As shown, device 105 includes application 107 that is paired with corresponding processes of platform 101 to help locate a project-a-shop in a particular geography. Also, the application 107 provides for features to enhance merchant services, such as the viewing of accrued loyalty points and redeeming for rewards.

By way of example, the project-a-shop service of platform 101 may include any widget, utility or application capable of being accessed by application 107 via a communication session established over data network 111 or wireless network 115 to service provider network 109. The application 107 may be installed on the device 105 and may feature one or more application programming interfaces (APIs) or call executions for activating the virtual shop service. As such, the application 107 may formulate a session with the platform 101 for exchanging data required for fulfilling transactions associated with the virtual shop service.

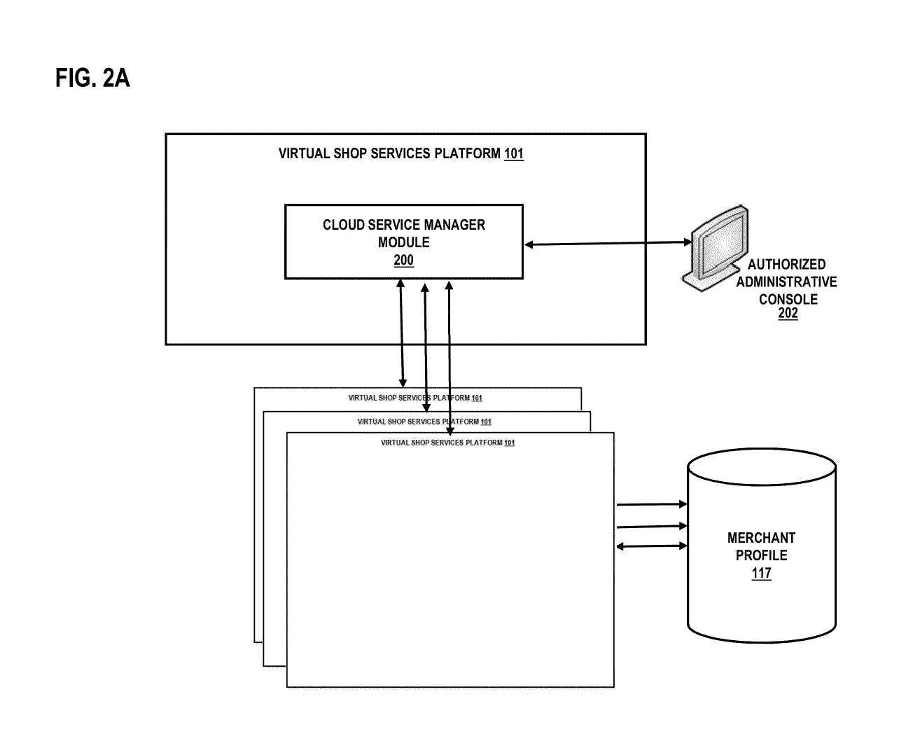

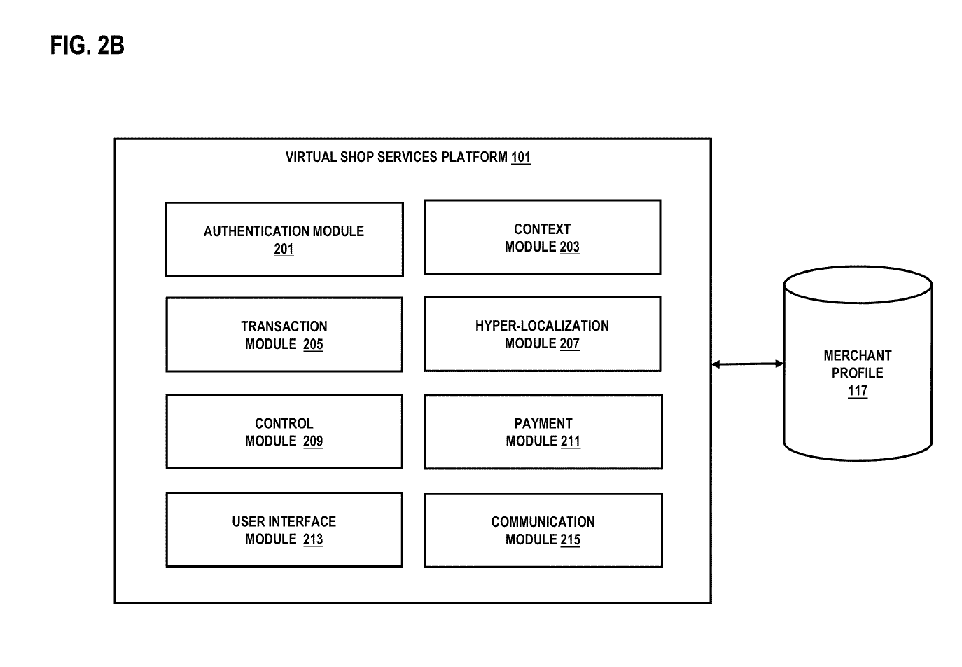

FIG. 2A is a diagram depicting the component that manages the lifecycle of virtual shop managed service instance, according to one embodiment. The cloud service manager module 200 is a component that manages the lifecycle of a virtual shop managed service instance. The lifecycle management includes the authorized administrative console 202 starting up, changing storage or caching or associated memory resources to, persisting and shutting down a virtual shop instance. Making a persistent copy of a virtual shop instance is the process of transforming an online only instance for rapid deployment as a virtual shop via the managed cloud service. It not only generates the shop instance for deployment, but also the companion mobile application that the consumer will use to interact with the shop and the attendant shop brand specific customization of icons.

FIG. 2B is a diagram depicting the components of a virtual shop services platform, according to one embodiment. The platform 101 includes various executable modules for performing one or more computing, data processing and network based instructions that in combination provide a means for enabling virtual shop services, as described in FIGS. 1, 3 and 4. Such modules can be implemented in hardware, firmware, software or a combination thereof. By way of example, the virtual shop services platform 103 may include an authentication module 201, a context module 203, a transaction module 205, a hyper-localization module 207, a control module 209, a payment module 211, a user interface module 213, and a communication module 215. These modules 201-211 can interact with merchant profile database 117 in support of their functions. In addition, the merchant profiles are maintained and updated based, at least in part, on one or more transactions conducted with user devices 105 pertaining to various applications and functions of merchant services 103a-103n.

In one embodiment, an authentication module 201 authenticates users (e.g., merchant users) and corresponding user devices 105 for interaction with the virtual shop services platform 103. The authentication procedure may be established a first time via a subscription process then later executed by the subscribed device for enabling profile activation. By way of example, the subscription procedure may include user entry of contact information, device information and user device usage preferences.

Context module 203 provides for the acquisition of contextual information from the user devices 105. Contextual information can include, for example, location of the device 105, whether certain activities on the device 105 have been performed, device specific information (e.g., type of device and the capabilities of the device), user specified preferences, etc.

Transaction module 205 can communicate with the merchant service 103a to ensure transaction data or information is exchanged properly. Module 205 can also govern any policies or rules related to how transactions are to be processed by the project-a-shop service.

The virtual shop services platform 101 also utilizes a hyper-localization module 207 to support a virtual store perimeter by determining the particular hyper-locale the device 105 is associated with. Module 207 can assist with selection locations associated with device 105 as part of the projection of the virtual store front. The module 207 operate in conjunction with the context module 203 so as to ensure that information that is contextual to a particular hyper-locale is accounted for and presented for the particular virtual store front. In addition, the module 207 tracks the user device 105 using any number of technologies, e.g., Global Positioning System (GPS), cellular triangulation, etc. Further, the hyper-localization module 207 can ensure that user device 105 is equipped with the hyper-location service, for example, by facilitating the download of necessary software to the device 105, as required. Hyper localization refers to the creation of an intra-grid tiling around the normal context of USNG tiles. For example, a typical 100 Sq. M area associated with a specific USNG tile is made up of 100 1 Sq. M hyper-located mini tiles, i.e. intra-grid tiling. The hyper-localization module provides the perimeter recognition of the mini-tiles with technologies that are fine grained such as NFC, Ultrasound, Infrared or magnetic field strengths for example as available via the User device 105 based hyper-localization services. These may be supported by special ASIC designs or via software based services enabled on the user device 105.

In one embodiment, the control module 209 controls the operations of the various other modules of the platform 101, including triggering execution of different modules accordingly. For example, control module 209 may invoke payment module 211 upon detecting that a transaction is valid and has triggered a billing or payment event. The payment module 211 can relay the necessary payment and/or billing information to the merchant service 103a. Module 211 thus operates in concert with application 107 of user device 105 for the transactions conducted by the virtual store front. The payment module 211 proxies the authentication credentials of the user device 105 to carry out the payment transaction. Because man-in-the-middle attacks are a common threat vector for mobile payments, the payment module 211 requests and obtains both a back end approval as well as a multi-factor authentication at the physical location. This captures the “where you are now” data point. Accordingly, two additional authentication components are requested from the shopper such as “what you are” and “what you know,” for example.

In certain embodiments, every visit to the physical location of the virtual shop (followed by interaction with the shop) results in the consumer accruing loyalty points. Incentive bonuses, which may be multiples of the typical accrual rate for loyalty points, are provided when the consumer makes purchases at the virtual shop. The payment module 211 can automatically default to the use of loyalty or incentive points based on purchases at the virtual shop as a basis for funding the current purchase. This funding is affected by the real time transformation of the loyalty currency—i.e. points accrued to a currency recognized for payment in the virtual shop and used to fund, in part or in whole, the current purchase.

In one embodiment, the user interface module 213 facilitates generation of various interfaces for enabling users to interact with the virtual shop services platform 101. This includes, for example, generation of a login interface for enabling user registration and/or access to the platform 101. In addition, the module 213 may provide a configuration interface for enabling users to generate merchant profiles. By way of example, the user interface module 213 may generate different user interface elements for selection by registered users. It is noted that the user interface module 213 may be activated by way of various application programming interfaces (APIs) or other function calls at a computing device of the third party content provider.

In one embodiment, the communication module 215 executes various protocols and data sharing techniques for enabling collaborative execution between the virtual shop services platform 101 and the applications 107 and/or user device 105. In addition, the communication module 215 enables generation of signals for communicating with various elements of the service provider network, including various gateways, policy configuration functions and the like.

The above described modules 201-215 and components of the virtual shop services platform 101 can be implemented in hardware, firmware, software, or a combination thereof. Though depicted as a separate entity in FIG. 1, it is contemplated that the platform 101 may be implemented for direct operation by various components of the service provider network. As such, the platform 101 generates direct signal inputs by way of the operating system of the network access point. In another embodiment, one or more of the modules 201-215 may be implemented for operation as a platform 101 maintained as a hosted or cloud based solution, as earlier noted.

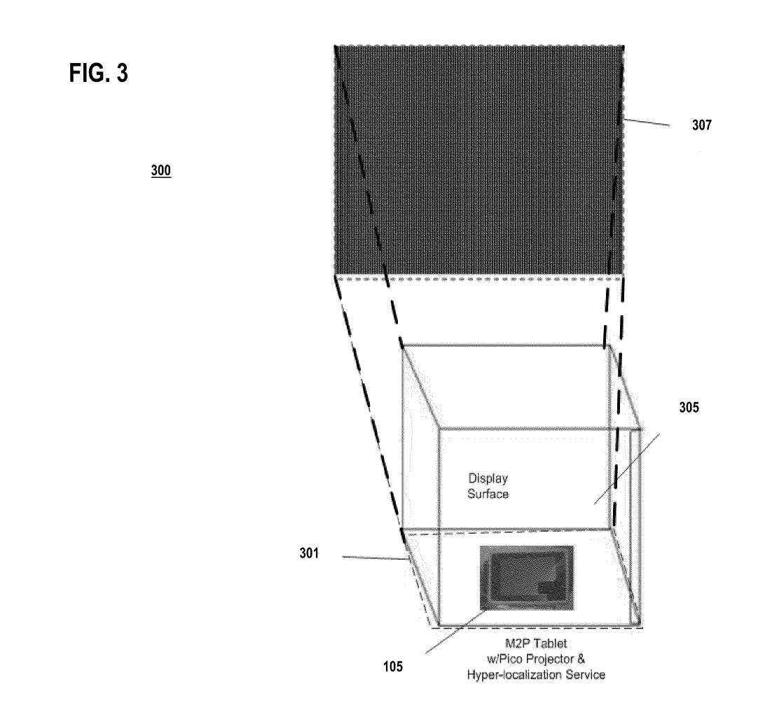

FIG. 3 is a diagram of a mobile device configured to project a user interface in support of a transient virtual shop, according to one embodiment. Under this scenario, user device 105 of FIG. 1 is a tablet computer configured with a pico-projector to effectively create a virtual kiosk as a store front. FIG. 3 shows an activated hyper-locale 300. The device 105 is situated at a particular geographic location, which can be tracked by the platform 101 as a M2P (Machine to Physical) location. In this example, the hyper locale in two-dimensional (2D) space is a perimeter 301 around this M2P location. According to certain embodiments, the volume of space contained by this cubic perimeter 301 serves as the active hyper local in three-dimensional (3D) space 305. As noted, the device 105 uses a pico-projector to project on to a passive display surface 307 with infrared return mapping. It could also use an ultrasound interface mapping as another example. In one embodiment, the 3D hyper locale 305 serves as the active selection space in which the user (e.g., consumer) works to make selections on projected content; while the device 105 is operated by the merchant user.

Selection capabilities include the interaction with, for example, inventory on display in the virtual shop (which may resemble an actual physical store). Other functions can include ordering and payment. As mentioned, platform 101 can support such merchant functions as the accrual of loyalty points and the attendant redemption of such points via the transient virtual shop. The user interaction is gesture-based, whereby movement of the consumer is tracked by device 105 in relation to the projected image as to provide for precise, distinct cursor movement. Hardware/software for implementing this gesture-based cursor control can be integrated with the user device 105, the pico-projector, or be a standalone peripheral device. The gesture detection, which is performed in real-time, is used to discover entry of the perimeter 301 and/or space 305 by the consumer. Application 107 on device 105 can incorporate a gesture based application programming interface (API). Device 105, for example, can employ multiple cameras to provide stereo scopic viewing.

It is contemplated that user device 105 may also be configured with an auto resolution function that, upon determining the presence of a user, in the perimeter 301, modifies the resolution of the display (projection). Similarly the user device 105 might go into sleep mode based on the lack of presence of the parameters needed to startup and maintain a display.

Given the above described arrangement, the consumer may make selections (i.e., provide input) off a wall using hand movements.

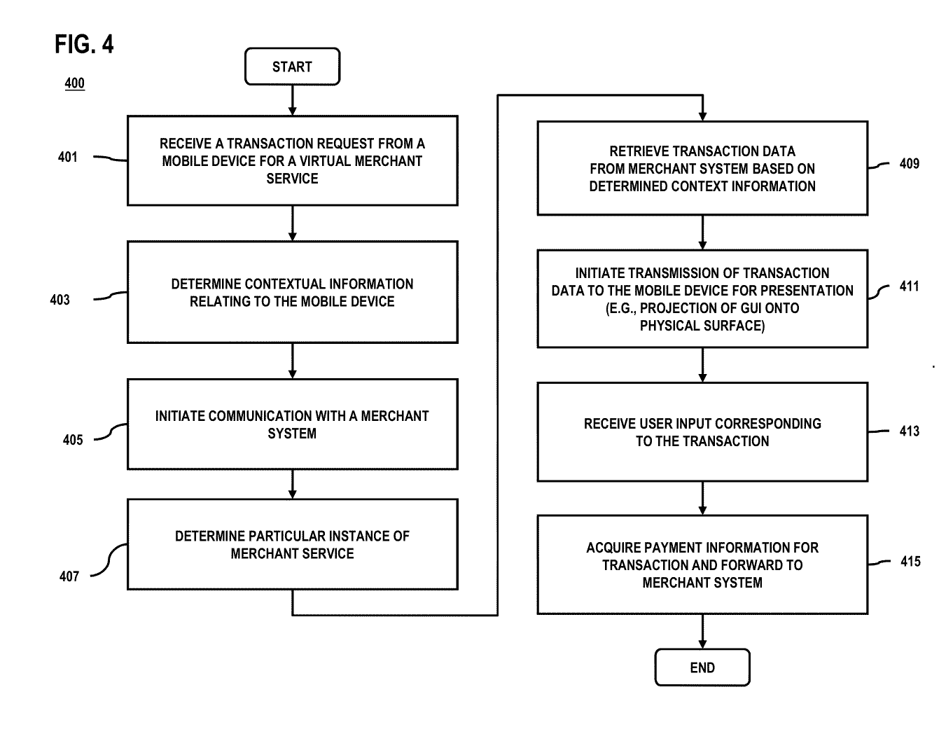

FIG. 4 is a flowchart of process for providing virtual shop services by a service provider, according to one embodiment. For the purpose of illustration, the processes are described with respect to FIG. 1. It is noted that the steps of the processes may be performed in any suitable order as well as combined or separated in any suitable manner. In this example, user device 105 may be any mobile device (e.g., tablet or mobile phone). Process 400 can be executed by platform 101, by way of example. In step 401, a transaction request is received, from mobile device 105, for a virtual merchant service. Contextual information relating to the mobile device is determined, per step 403. For example, the contextual information may be information about surrounding stores. Such information may be used to target certain products and services that the consumer may be interested in (as the person is near a particular store). In step 405, communication is initiated with a merchant system configured to facilitate a transaction associated with the merchant service.

It is contemplated that merchant service 103a may provide any number of project-a-shop instances (e.g., to provide different products/services), as the interface may be too complex or inefficient if more all products and services are covered by a single instance. Moreover, the instance may be selected based on the contextual information and/or hyper-locale (it is noted that contextual information can be defined to include the hyper-locale information as well). In one embodiment, the contextual information specifies a limited geographical location perimeter for the device 105. Accordingly, the process 400, per step 407, determines a particular instance among a plurality of instances of the merchant service 103a. It is contemplated that the instance can reflect inventory that is unique to the instance. As such, inventory information can reflect the particular instance and be supplied as part of the transaction data.

Transaction data, per step 409, is received from the merchant system based on the determined contextual information. Transmission of the transaction data is initiated to the device 105 for presentation. The presentation, in certain embodiments, includes projecting a graphical user interface (GUI) to represent the transaction data. As mentioned, the graphical user interface can support gesture-based input. In step 413, user input corresponding to the transaction is received via the graphical user interface. Thereafter, per step 415, payment information for the transaction can be acquired via the graphical user interface; and forwarded to the merchant system (e.g., merchant service 103a).

In certain embodiments, the merchant system (e.g., merchant service 103a) can be configured to synchronize inventory of a physical store with the virtual merchant service. The inventory information can then be updated with respect to time of the receipt of the transaction request.

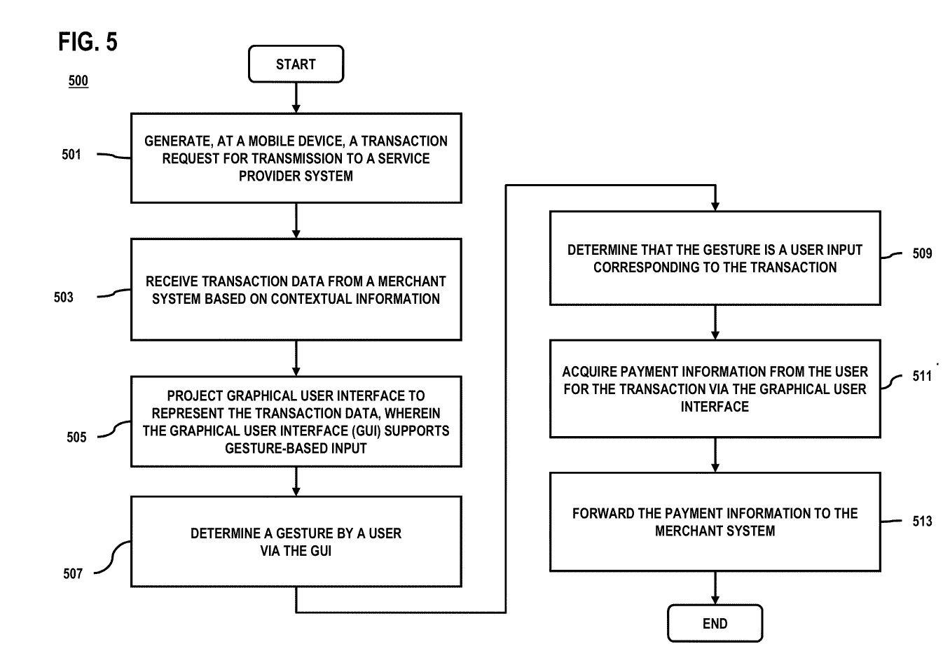

FIG. 5 is a flowchart of process for providing interaction via a mobile device in support of virtual shop services, according to one embodiment. For the purpose of illustration, the processes are described with respect to FIG. 1. It is noted that the steps of the processes may be performed in any suitable order as well as combined or separated in any suitable manner. In this use case, a merchant user operates device 105, which may be a mobile device such as a smartphone that is equipped with projection display capability as well as gesture-based detection capability. Process 500 thus can be performed by device 105 through the execution of application 107, for example.

In step 501, process 500 generates a transaction request for transmission to a service provider system (e.g., virtual shop services platform 101). As in the scenario of FIG. 3, the transaction request relates to a virtual merchant service and specifies contextual information relating to the device 105. Transaction data is received, as in step 503, from a merchant system (e.g., merchant service 103a) based on the determined contextual information. By way of example, the transaction data includes inventory information, and the contextual information specifies a limited geographical location perimeter. As noted, the merchant service 103a is configured to synchronize inventory of a physical store with the virtual merchant service. As such, the inventory information is updated with respect to time of the receipt of the transaction request. Next, a user interface (e.g., graphical user interface (GUI) is projected to represent the transaction data. The graphical user interface supports gesture-based input.

Under this scenario, device 105 projects the graphical user interface to reflect a particular instance (among a plurality of instances of the merchant service) such that the inventory information is specific to the particular instance (per step 505).

In step 507, process 500 detects a gesture by a user via the graphical user interface; and in step 509, the process 500 determines that the gesture is a user input corresponding to the transaction. Subsequently, payment information can be acquired from the user for the transaction via the graphical user interface (step 511). In step 513, the payment information is forwarded to platform 101 and ultimately to the merchant system (e.g., merchant service 103a).

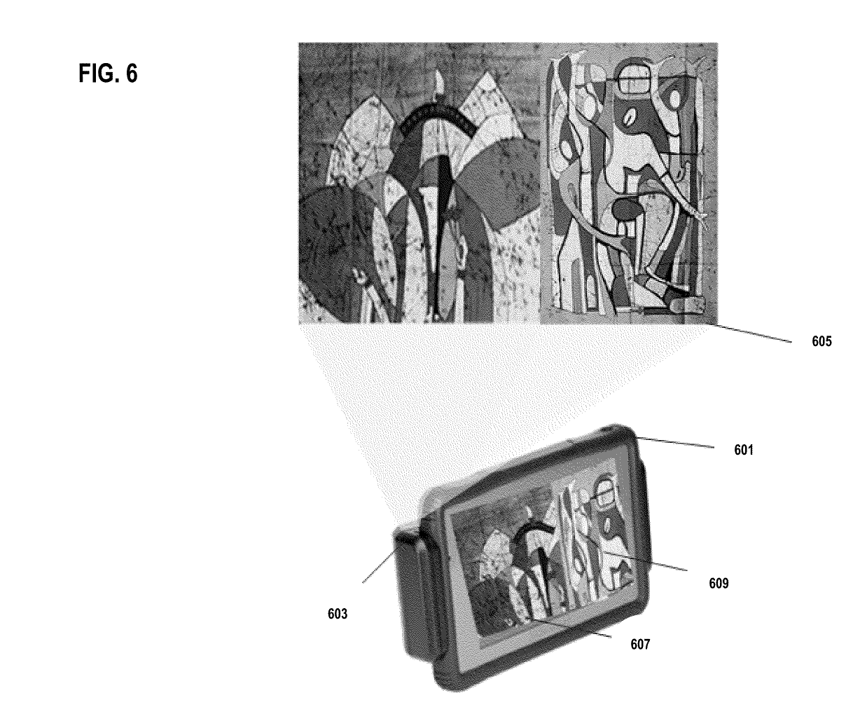

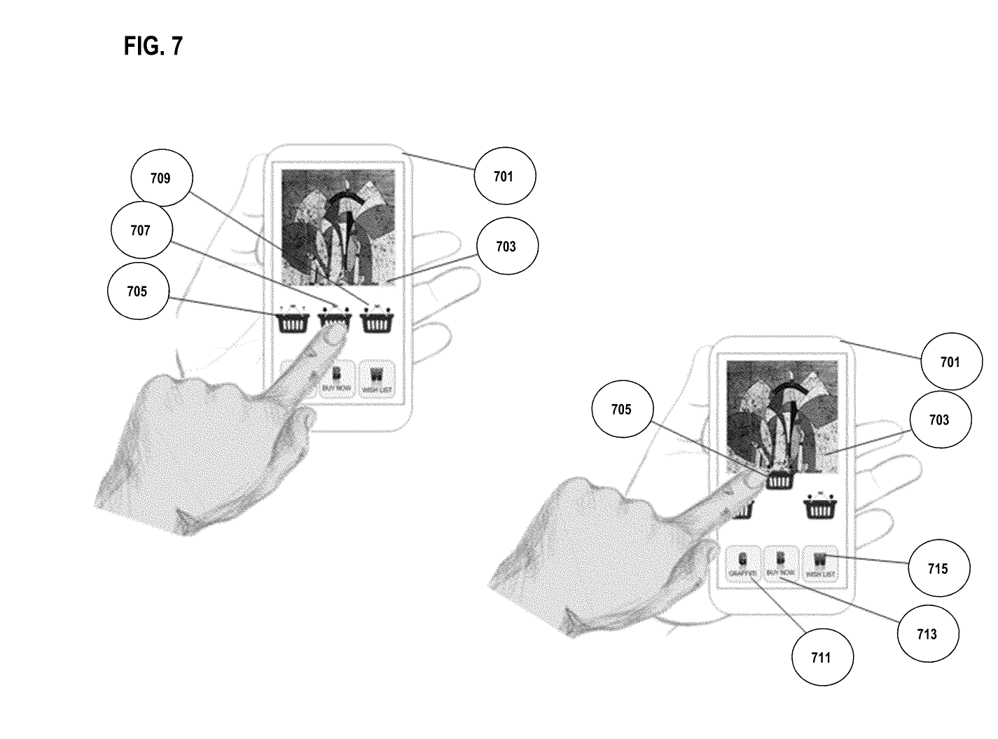

The processes of FIGS. 4 and 5 can be performed by any number of device configurations, as explained with respect to FIGS. 6 and 7.

FIG. 6 is a diagram of a mobile device configured to project a user interface in support of a transient virtual shop from a shop-side perspective, according to one embodiment. In the example of FIG. 6, a rugged machine-to-physical tablet 601 couples to a pico-projector 603 that affixes to the tablet 601 on the back as a holder. The projection is provided onto a wall as a graphical user interface 605. This use case also provides for the GUI to be present on the display of the tablet 601, in which certain items 607 and 609 are presented, for selection, to a user (consumer). The consumer (e.g., potential buyer) would utilize the interface 605 that is projected to make a selection of item 607 or item 609. The dual display essentially permits the consumer to be more engrossed in the virtual store front, and select items from that projected interface. Alternatively or additionally, the consumer may verbalize the selection and tell the merchant user (operator of the device 601) of the particular selection.

In one embodiment, the projected display 605 may differ from the user device's display as to permit the merchant user different control options, as depicted in FIG. 7.

FIG. 7 is a diagram of a use case involving a consumer-side user interface relating to a transient virtual shop, according to one embodiment. In this use case, a mobile device 701 has a consumer side application 107 that interacts with the projected virtual shop display. Here, display 703, includes various icons 705, 707, 709 relating to shopping basket (or shopping cart) functions) and icons 711, 713, and 715 representing various other transaction functions. Once the consumer application 107 captures the item from the display in the displayed view basic shopping functions are enabled on the consumers device 105 via the icons 705, 707, and 709 and buttons 711, 713, and 715. Shopping basket icon 705 can specify, for instance, a function to invoke the display of the shopping basket (either enabling presentation of the icon onto the projection and/or mobile device display). Shopping basket icon 707 is a “put into” basket function so that the selected item is captured as part of the transaction. A remove from basket function is also provided in form of icon 709.

By way of example, other transaction functions are provided by icons 711, 713, and 715. Icon 711 can permit, for example, the user to write up a description or message about the particular item at this location, while icon 713 initiates the purchase of the items in the shopping basket. Further, a “wish list” function, as represented by icon 715, enables the user to designate the item for future consideration for purchase.

Icon 711 provides the ability to a consumer using the application 107 to leave, for example, virtual graffiti-like remarks at a shop location encouraging social interaction. The hyper-location enabled services allows for the shop's location when operational to determine the nature of the viewership of this virtual graffiti ranging from publicly visible comments to private gifts left for friends. An example of such private gifting is leaving accrued loyalty points from a purchase made at the virtual shop at the shop location for pickup by a friend who may visit the physical location of this virtual shop at a later date. Consumers, who elect to leave social messages that are viewed by others, can earn extra loyalty points. Permissions associated for leaving a gift may include the provision of a social network (e.g., FACEBOOK™) login credentials. Using the permissions to provide further suggestions on friends, who could benefit from the application download and who are not yet taking advantage of this type of interaction, is a key component of the social proliferation of the consumer application associated with a specific virtual shop instance.

It is contemplated that any number of other transaction function may be devised and presented on display 703 depending on the requirements of the merchant service 103. These are instantiated and associated with the consumer application 107 used at the virtual shop at the time of the instantiation of the virtual shop instance using the cloud service manager module 200 and can be updated or reissued by making different choices via the authorized administrative console 202.

The described approach of FIGS. 3-7, for example, advances the state of the kiosk and retail industry by providing a mobile device that is capable of running the machine to physical hyper-localization services (e.g., supported by 4G LTE or suitable WiFi based broadband connectivity) to create a transient store from an existing merchant network based shop. In some embodiments, the device in conjunction with a backend (as provided by platform 101) also provides for payments, loyalty and incentive redemption for the transient virtual shop without requirements for systems integration.

The processes described herein for providing a transient virtual shop may be implemented via software, hardware (e.g., general processor, Digital Signal Processing (DSP) chip, an Application Specific Integrated Circuit (ASIC), Field Programmable Gate Arrays (FPGAs), etc.), firmware or a combination thereof. Such exemplary hardware for performing the described functions is detailed below.

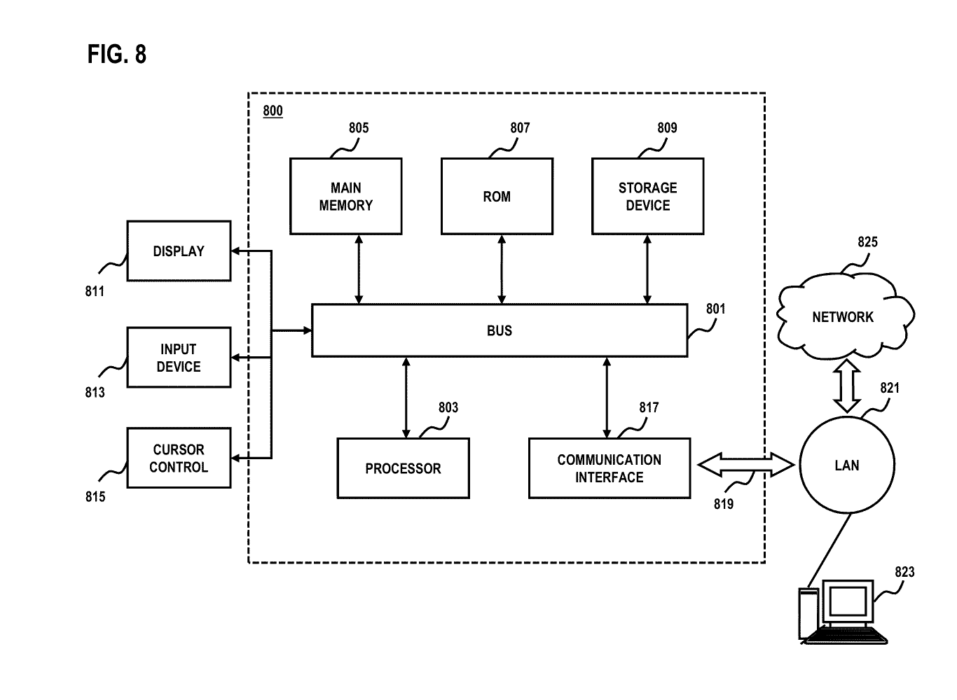

FIG. 8 is a diagram of a computer system that can be used to implement various exemplary embodiments. The computer system 800 includes a bus 801 or other communication mechanism for communicating information and one or more processors (of which one is shown) 803 coupled to the bus 801 for processing information. The computer system 800 also includes main memory 805, such as a random access memory (RAM) or other dynamic storage device, coupled to the bus 801 for storing information and instructions to be executed by the processor 803. Main memory 805 can also be used for storing temporary variables or other intermediate information during execution of instructions by the processor 803. The computer system 800 may further include a read only memory (ROM) 807 or other static storage device coupled to the bus 801 for storing static information and instructions for the processor 803. A storage device 809, such as a magnetic disk or optical disk, is coupled to the bus 801 for persistently storing information and instructions.

The computer system 800 may be coupled via the bus 801 to a display 811, such as a cathode ray tube (CRT), liquid crystal display, active matrix display, or plasma display, for displaying information to a computer user. An input device 813, such as a keyboard including alphanumeric and other keys, is coupled to the bus 801 for communicating information and command selections to the processor 803. Another type of user input device is a cursor control 815, such as a mouse, a trackball, or cursor direction keys, for communicating direction information and command selections to the processor 803 and for adjusting cursor movement on the display 811.

According to an embodiment of the invention, the processes described herein are performed by the computer system 800, in response to the processor 803 executing an arrangement of instructions contained in main memory 805. Such instructions can be read into main memory 805 from another computer-readable medium, such as the storage device 809. Execution of the arrangement of instructions contained in main memory 805 causes the processor 803 to perform the process steps described herein. One or more processors in a multi-processing arrangement may also be employed to execute the instructions contained in main memory 805. In alternative embodiments, hard-wired circuitry may be used in place of or in combination with software instructions to implement the embodiment of the invention. Thus, embodiments of the invention are not limited to any specific combination of hardware circuitry and software.

The computer system 800 also includes a communication interface 817 coupled to bus 801. The communication interface 817 provides a two-way data communication coupling to a network link 819 connected to a local network 821. For example, the communication interface 817 may be a digital subscriber line (DSL) card or modem, an integrated services digital network (ISDN) card, a cable modem, a telephone modem, or any other communication interface to provide a data communication connection to a corresponding type of communication line. As another example, communication interface 817 may be a local area network (LAN) card (e.g. for Ethernet™ or an Asynchronous Transfer Mode (ATM) network) to provide a data communication connection to a compatible LAN. Wireless links can also be implemented. In any such implementation, communication interface 817 sends and receives electrical, electromagnetic, or optical signals that carry digital data streams representing various types of information. Further, the communication interface 817 can include peripheral interface devices, such as a Universal Serial Bus (USB) interface, a PCMCIA (Personal Computer Memory Card International Association) interface, etc. Although a single communication interface 817 is depicted, multiple communication interfaces can also be employed.

The network link 819 typically provides data communication through one or more networks to other data devices. For example, the network link 819 may provide a connection through local network 821 to a host computer 823, which has connectivity to a network 825 (e.g. a wide area network (WAN) or the global packet data communication network now commonly referred to as the “Internet”) or to data equipment operated by a service provider. The local network 821 and the network 825 both use electrical, electromagnetic, or optical signals to convey information and instructions. The signals through the various networks and the signals on the network link 819 and through the communication interface 817, which communicate digital data with the computer system 800, are exemplary forms of carrier waves bearing the information and instructions.

The computer system 800 can send messages and receive data, including program code, through the network(s), the network link 819, and the communication interface 817. In the Internet example, a server (not shown) might transmit requested code belonging to an application program for implementing an embodiment of the invention through the network 825, the local network 821 and the communication interface 817. The processor 803 may execute the transmitted code while being received and/or store the code in the storage device 809, or other non-volatile storage for later execution. In this manner, the computer system 800 may obtain application code in the form of a carrier wave.

The term “computer-readable medium” as used herein refers to any medium that participates in providing instructions to the processor 803 for execution. Such a medium may take many forms, including but not limited to computer-readable storage medium ((or non-transitory)—i.e., non-volatile media and volatile media), and transmission media. Non-volatile media include, for example, optical or magnetic disks, such as the storage device 809. Volatile media include dynamic memory, such as main memory 805. Transmission media include coaxial cables, copper wire and fiber optics, including the wires that comprise the bus 801. Transmission media can also take the form of acoustic, optical, or electromagnetic waves, such as those generated during radio frequency (RF) and infrared (IR) data communications. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, and EPROM, a FLASH-EPROM, any other memory chip or cartridge, a carrier wave, or any other medium from which a computer can read.

Various forms of computer-readable media may be involved in providing instructions to a processor for execution. For example, the instructions for carrying out at least part of the embodiments of the invention may initially be borne on a magnetic disk of a remote computer. In such a scenario, the remote computer loads the instructions into main memory and sends the instructions over a telephone line using a modem. A modem of a local computer system receives the data on the telephone line and uses an infrared transmitter to convert the data to an infrared signal and transmit the infrared signal to a portable computing device, such as a personal digital assistant (PDA) or a laptop. An infrared detector on the portable computing device receives the information and instructions borne by the infrared signal and places the data on a bus. The bus conveys the data to main memory, from which a processor retrieves and executes the instructions. The instructions received by main memory can optionally be stored on storage device either before or after execution by processor.

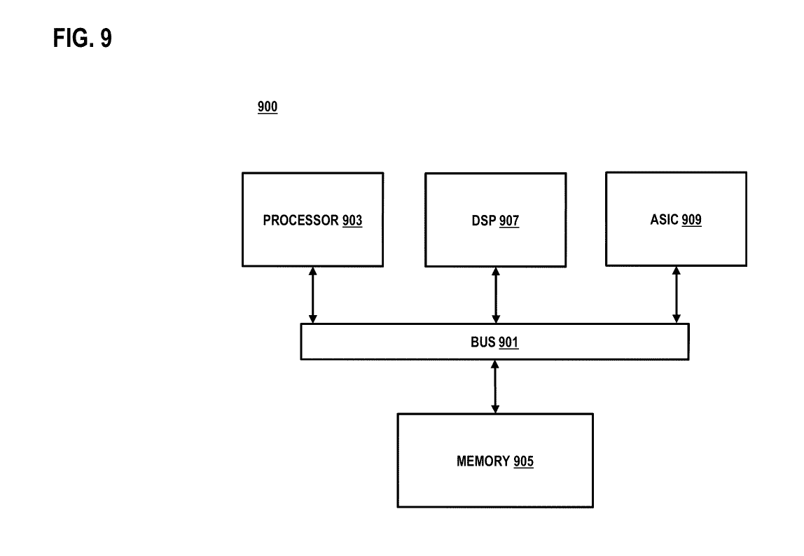

FIG. 9 illustrates a chip set or chip 900 upon which an embodiment of the invention may be implemented. Chip set 900 is programmed for to enable controlled access to a limited set of remote services associated with a device as described herein and includes, for instance, the processor and memory components described with respect to FIG. 8 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set 900 can be implemented in a single chip. It is further contemplated that in certain embodiments the chip set or chip 900 can be implemented as a single “system on a chip.” It is further contemplated that in certain embodiments a separate ASIC would not be used, for example, and that all relevant functions as disclosed herein would be performed by a processor or processors. Chip set or chip 900, or a portion thereof, constitutes a means for performing one or more steps of enabling controlled access to a limited set of remote services associated with a device.

In one embodiment, the chip set or chip 900 includes a communication mechanism such as a bus 901 for passing information among the components of the chip set 900. A processor 903 has connectivity to the bus 901 to execute instructions and process information stored in, for example, a memory 905. The processor 903 may include one or more processing cores with each core configured to perform independently. A multi-core processor enables multiprocessing within a single physical package. Examples of a multi-core processor include two, four, eight, or greater numbers of processing cores. Alternatively or in addition, the processor 903 may include one or more microprocessors configured in tandem via the bus 901 to enable independent execution of instructions, pipelining, and multithreading. The processor 903 may also be accompanied with one or more specialized components to perform certain processing functions and tasks such as one or more digital signal processors (DSP) 907, or one or more application-specific integrated circuits (ASIC) 909. A DSP 907 typically is configured to process real-world signals (e.g., sound) in real time independently of the processor 903. Similarly, an ASIC 909 can be configured to performed specialized functions not easily performed by a more general purpose processor. Other specialized components to aid in performing the inventive functions described herein may include one or more field programmable gate arrays (FPGA) (not shown), one or more controllers (not shown), or one or more other special-purpose computer chips.

In one embodiment, the chip set or chip 900 includes merely one or more processors and some software and/or firmware supporting and/or relating to and/or for the one or more processors.

The processor 903 and accompanying components have connectivity to the memory 905 via the bus 901. The memory 905 includes both dynamic memory (e.g., RAM, magnetic disk, writable optical disk, etc.) and static memory (e.g., ROM, CD-ROM, etc.) for storing executable instructions that when executed perform the inventive steps described herein for to enable controlled access to a limited set of remote services associated with a device. The memory 905 also stores the data associated with or generated by the execution of the inventive steps.

While certain exemplary embodiments and implementations have been described herein, other embodiments and modifications will be apparent from this description. Accordingly, the invention is not limited to such embodiments, but rather to the broader scope of the presented claims and various obvious modifications and equivalent arrangements.

1. A method comprising:
receiving a transaction request, from a mobile device, for a virtual merchant service;
determining, by a processor, contextual information relating to the mobile device;
initiating communication with a merchant system configured to facilitate a transaction associated with the merchant service;
retrieving transaction data from the merchant system based on the determined contextual information;
initiating transmission of the transaction data to the mobile device for presentation, wherein the presentation includes projecting a graphical user interface to represent the transaction data, wherein the graphical user interface supports gesture-based input; and
receiving user input, via the graphical user interface, corresponding to the transaction.

2. A method according to claim 1, wherein the transaction data includes inventory information, and the contextual information specifies a limited geographical location perimeter, the method further comprising:
determining a particular instance among a plurality of instances of the merchant service, wherein the inventory information is specific to the particular instance.

3. A method according to claim 2, wherein the merchant system is configured to synchronize inventory of a physical store with the virtual merchant service, the inventory information being updated with respect to time of the receipt of the transaction request.

4. A method according to claim 1, further comprising:
acquiring payment information for the transaction via the graphical user interface; and
forwarding the payment information to the merchant system.

5. A method according to claim 1, wherein the transaction request is received at a service provider cloud-based system, and the merchant system is a cloud-based system.

6. An apparatus comprising:
at least one processor; and
at least one memory including computer program code for one or more programs, the at least one memory and the computer program code configured to, with the at least one processor, cause the apparatus to perform at least the following, receive a transaction request, from a mobile device, for a virtual merchant service;
determine contextual information relating to the mobile device, initiate communication with a merchant system configured to facilitate a transaction associated with the merchant service,
retrieve transaction data from the merchant system based on the determined contextual information,
initiate transmission of the transaction data to the mobile device for presentation, wherein the presentation includes projecting a graphical user interface to represent the transaction data, wherein the graphical user interface supports gesture-based input, and
receive user input, via the graphical user interface, corresponding to the transaction.

7. An apparatus according to claim 6, wherein the transaction data includes inventory information, and the contextual information specifies a limited geographical location perimeter, the apparatus being further caused to:
determine a particular instance among a plurality of instances of the merchant service, wherein the inventory information is specific to the particular instance.

8. An apparatus according to claim 7, wherein the merchant system is configured to synchronize inventory of a physical store with the virtual merchant service, the inventory information being updated with respect to time of the receipt of the transaction request.

9. An apparatus according to claim 6, wherein the apparatus is further caused to:
acquire payment information for the transaction via the graphical user interface; and
forward the payment information to the merchant system.

10. An apparatus according to claim 6, wherein the transaction request is received at a service provider cloud-based system, and the merchant system is a cloud-based system.

11. A method comprising:
generating, at a mobile device, a transaction request for transmission to a service provider system, wherein the transaction request relates to a virtual merchant service and specifies contextual information relating to the mobile device;
receiving, by a processor, transaction data from a merchant system based on the contextual information; and
projecting a graphical user interface to represent the transaction data, wherein the graphical user interface supports gesture-based input.

12. A method according to claim 11, further comprising:
detecting a gesture by a user via the graphical user interface; and
determining that the gesture is a user input corresponding to the transaction.

13. A method according to claim 11, wherein the transaction data includes inventory information, and the contextual information specifies a limited geographical location perimeter, the method further comprising:
projecting the graphical user interface to reflect a particular instance among a plurality of instances of the merchant service, wherein the inventory information is specific to the particular instance.

14. A method according to claim 13, wherein the merchant system is configured to synchronize inventory of a physical store with the virtual merchant service, the inventory information being updated with respect to time of the receipt of the transaction request.

15. A method according to claim 13, further comprising:
acquiring payment information from the user for the transaction via the graphical user interface; and
forwarding the payment information to the merchant system.

16. An apparatus comprising:
at least one processor; and
at least one memory including computer program code for one or more programs, the at least one memory and the computer program code configured to, with the at least one processor, cause the apparatus to perform at least the following,
generate, at a mobile device, a transaction request for transmission to a service provider system, wherein the transaction request relates to a virtual merchant service and specifies contextual information relating to the mobile device,
receive transaction data from a merchant system based on the contextual information, and
project a graphical user interface to represent the transaction data, wherein the graphical user interface supports gesture-based input.

17. An apparatus according to claim 16, wherein the apparatus is further caused to:
detect a gesture by a user via the graphical user interface; and
determine that the gesture is a user input corresponding to the transaction.

18. An apparatus according to claim 16, wherein the transaction data includes inventory information, and the contextual information specifies a limited geographical location perimeter, the apparatus being further caused to:
project the graphical user interface to reflect a particular instance among a plurality of instances of the merchant service, wherein the inventory information is specific to the particular instance.

19. An apparatus according to claim 18, wherein the merchant system is configured to synchronize inventory of a physical store with the virtual merchant service, the inventory information being updated with respect to time of the receipt of the transaction request.

20. An apparatus according to claim 18, wherein the apparatus is further caused to:
acquire payment information from the user for the transaction via the graphical user interface; and
forward the payment information to the merchant system.
